(19) United States
(12) Patent Application Publication
(10) Pub. No.: US 2004/0020510 A1
(43) Pub. Date: Feb. 5, 2004

(54) Method for cleaning of porous material by use of carbon dioxide and arrangement for carrying out said method

(76) Inventor: Rutger Roseen, Stockholm (SE)

Correspondence Address: PEARNE & GORDON LLP, 1801 EAST 9TH STREET, SUITE 1200, CLEVELAND, OH, 44114-3108, US

(21) Appl. No.: 10/169,036

(22) PCT Filed: Dec. 22, 2000
(86) PCT No.: PCT/SE00/02651

(30) Foreign Application Priority Data
Dec. 27, 1999 (SE) 122799

(51) Int. Cl. B08B 3/12

(52) U.S. Cl. 134/1; 134/19; 134/25.4; 134/42; 134/105; 134/184; 62/62; 62/115

(57) ABSTRACT

The invention refers to a method and an arrangement for cleaning of porous materials, in particular textiles, in liquid carbon dioxide which by rapid, intermittent pressure drops is brought into boiling. Various ways of lowering and then again increasing the pressure in the chamber in which the cleaning takes place are described. The arrangement for carrying out the method comprises a pressure chamber (1) in which the goods (2) to be washed is treated, an adjacent container (13, 14) for the control of the carbon dioxide pressure in the pressure chamber (1), suitably a storage tank (7) for liquid carbon dioxide, a compressor (20) for supplying high-pressure gas into the pressure chamber, when necessary, a pump (10) for the transport of liquid carbon dioxide and the required connecting conduits between the volume vessels mentioned and, stop valves in these conduits.

The present invention refers to a method for washing of porous materials, in particular textiles, by using liquid carbon dioxide as an alternative to dry-cleaning, and an arrangement for carrying out the method.

In spite of the development of washing liquids for dry-cleaning such liquids are still harmful to nature and even closed systems for reuse of such liquids are not completely tight so that in dry-cleaning establishments leakage to the environment can take place. In addition, the washing liquids of to-day, based on e.g. perchloroethylene, are not suitable in removing for example perspiration products from garments. Accordingly, from an environment protective view it is desirable to find a washing medium which is environmental friendly in that discharge from a dry-cleaning establishment in the form of evaporated washing liquid does not negatively influence on nature.

Such a medium is known from the prior art, namely carbon dioxide (CO₂). This medium is advantageous in that it can be extracted from the surrounding atmosphere and when used in connection with laundry washing, leakage gas and possible blowout can freely be allowed to escape into the open air. Accordingly, there is no influence on the green-house effect. Liquid carbon dioxide has certain dissolving properties clearly superior to those of water and at suitable temperature and pressure levels carbon dioxide has a density which is clearly below the density of water. Due to the fact that carbon dioxide can be used as washing liquid together with water such combination can dissolve dirt from textiles that cannot be removed in a water wash. Accordingly, carbon dioxide, alone or combined with water, can not only replace dry-cleaning liquids but have also superior washing properties.

The favourable dissolving properties of carbon dioxide, in particular in supercritical condition, are previously known. Methods involving carbon dioxide gas of a pressure of up to 10 MPa and more above its liquid phase have been used. Such a method is described in U.S. Pat. No. 5,267,455.

More moderate pressures are used in a method according to U.S. Pat. No. 5,651,276 in which an attempt is made to stir the laundry as a kind of mechanical treatment by pumping carbon dioxide gas through nozzles directed towards the laundry. Another method for bringing the laundry to move in the liquid carbon dioxide is to use impellers in the liquid. Such mechanical treatment of the laundry is intended to improve the contact between the textiles and the washing liquid, i.e. the liquid carbon dioxide.

Thus, it is a known problem that the contact between the laundry and the washing liquid spontaneously will not be complete when the liquid is introduced into the treatment vessel used. On certain kinds of textile fibres liquid carbon dioxide has a somewhat too low wetting ability to quickly reach dirt between thin fibres.

The object of the invention is to offer a method for dissolving dirt and impurities out of cavities of porous materials, in particular textile fibres, by using liquid carbon dioxide in non-supercritical state. The object is achieved by intermittently and rapidly lowering the pressure of the liquid carbon dioxide. In order to improve the cleaning result in case of certain kinds of dirt the washing liquid can be composed of the carbon dioxide, water and tensides and complex-forming agents dissolved therein.

In order to carry out the method an arrangement has been invented of which the simplest embodiment comprises a treatment chamber, a container for storing of liquid carbon dioxide and a pump for the transport thereof through connecting pipes, as well as stop valves.

Generally, the simplest form of the method can be said to be very similar to the old-fashioned wash taking place in a wash boiler. During such old-fashioned wash there was a minimum degree of mechanical treatment of the laundry in that during the process the laundry was brought around by a wooden stick to complete a few revolutions. The dissolving of the dirt was a chemical process but the effectiveness thereof was dependent on the ability of the wash liquor to penetrate into the textile fibres. This was achieved by heating, in certain cases to a boiling level. By the function of the washing agents to lower the boiling point, also at temperatures far below 100° C. forming of steam bubbles took place among the fibres. When the steam bubbles moved upwards and agglomerated a micro-mechanical treatment of the laundry was effected and simultaneously the contact surfaces between the dirt on the fibres and the solvent in the wash liquor changed. As a result, both dissolving of binding agents between different dirt particles and a removal of particles thus loosened took place.

The cleaning method according to the invention functions correspondingly. The laundry is placed in a pressure chamber at room temperature and the chamber is closed and partly filled with liquid carbon dioxide. Part of the carbon dioxide is evaporated and when additional liquid carbon dioxide is pumped into the pressure chamber the pressure in the chamber is caused to increase to the desired level. Hereby, the fibres are wet by the carbon dioxide and, dependent on the fibre material, part of the carbon dioxide is absorbed by the fibres. By providing, in the pressure chamber, or close thereto, a non-pressurized container, which is connected to the interior of the pressure chamber via a pipe connection provided with a stop valve, upon opening of the stop valve gas can rapidly be conveyed from the pressure chamber to the container which causes the pressure in the chamber to rapidly decrease. This decrease in pressure causes the carbon dioxide, the boiling point of which is 194,7° K (−78,5° C.), to become heavily superheated and momentarily start boiling. Then, the valve is closed in the pipe connection to the container which is filled with carbon dioxide gas of the same pressure as is prevailing in the chamber. During the boiling of the carbon dioxide, which is almost explosive, steam bubbles will be created on the fibres of the textiles. This is to be considered as a micro-mechanical treatment of the laundry and, in addition, when the boiling ceases fresh carbon dioxide gets into contact with the fibres.

The boiling in the carbon dioxide liquid ceases, partly because heat is taken from the liquid for the creation of steam (at 2 Mpa: 320 kJ/kg) so that the temperature of the liquid decreases, and partly due to the fact that a pressure equilibrium arises when the pressure above the liquid increases.

The carbon dioxide gas collected in the container can be evacuated to the atmosphere, which is expensive, or led for re-circulation to a storage tank via a pipe conduit provided with a stop valve. By being compressed, the gas can then be returned as liquid into the process. Before atmospheric pressure has been achieved in the container a new boiling cycle can be initiated in the pressure chamber by closing the outlet from the container and again rapidly open the stop valve between the pressure chamber and the container. After every boiling cycle the amount of liquid carbon dioxide decreases at the same time as its temperature decreases by sensible heat being transferred into vaporization energy. Compensation therefor can take place either by pumping liquid carbon dioxide from the storage tank to the pressure chamber or by heating the liquid carbon dioxide in the pressure chamber in a suitable way.

One way of economizing the use of the carbon dioxide is to provide a short-circuit re-circulation of it between the container and the pressure chamber. In this method a compressor is used which sucks carbon dioxide from the pressure chamber and supplies it to an ejector pump. The suction side of the pump is connected to the container and it delivers into the pressure chamber.

In accordance with the method it is also possible to supply water to the pressure chamber. Carbon dioxide has a relatively low grade of solubility in water and, therefore, water is not affected as dissolving agent for tensides and complex forming agents. Hereby, in the liquid carbon dioxide detergents suitable for water wash can be used together with the amount of water required to dissolve the detergents. In this way a good dry-cleaning result is achieved and at the same time a good water wash result.

For carrying out the inventive method an arrangement has been invented with the characterizing features indicated in the appending claims.

In its simplest form the arrangement comprises a pressure chamber, in which the laundry is placed, a container for the intermittent control of the pressure in the pressure chamber, connection conduits between these two provided with stop valves, and a pump for the circulation of washing liquid through the arrangement. By proper disposition of the container liquid carbon dioxide can be conveyed by gravity from the pressure chamber to the container.

In performing a more sophisticated washing program a compressor can be provided in the circulation conduit which compresses vaporized washing liquid into liquid phase. It can be advantageous to connect a storage tank for washing liquid to the arrangement via a pipe conduit provided with a stop valve and a built-in pump so that waste liquid can be replaced.

Irrespective of the method is carried out with just carbon dioxide as washing agent or if also water and tensides and/or complex forming agents dissolved therein are included dirt remainders will deposit on the bottom of the pressure chamber. In one embodiment it has been found advantageous to provide for a sump in the bottom of the chamber for collecting the deposits. A discharge pipe, provided with a stop valve, is connected to the sump for discharge of the dirt remainders. The dirt will otherwise accumulate in the chamber.

Even if the method carried out in the simplest embodiment of the arrangement offers a good cleaning result there are reasons for developing the arrangement imitating the design of commonly used horizontal shaft machines for water wash or dry-cleaning wash. Accordingly, a variant of the arrangement has been provided with a cylindrical drum having a perforated envelope surface and being adapted for reversible operation. A driving motor for the drum can be disposed outside of the pressure chamber but due to the high pressure during the execution of the method the shaft lead-through in the wall of the pressure chamber would cause sealing problems. Surprisingly, it has shown that arranging an electric driving motor for the wash drum in the pressure chamber does not involve any problems.

An alternative way of rotating the wash drum offered when the evacuation pump at the container for the control of the pressure in the pressure chamber is of the ejector type is to let the ejector jet from the pump drive one or several impellers secured to a shaft which supports the drum and extends from a closed gable thereof. When two impellers are used these are rotated in opposite directions so that by alternately shifting the ejector jet the drum can be given alternating directions of rotation. For the effective use of the power of the ejector jet the arrangement is provided with a partition disposed between the impellers and fixed to a common shaft thereof.

For the understanding of the inventive method a description will be given below as part of the description of two preferred embodiments of arrangements for performing of the method with reference given to the drawings. In two drawing figures there is schematically shown a vertical section through the pressure chamber and the container for gas pressure control illustrating the principal construction of preferred embodiments of the invention.

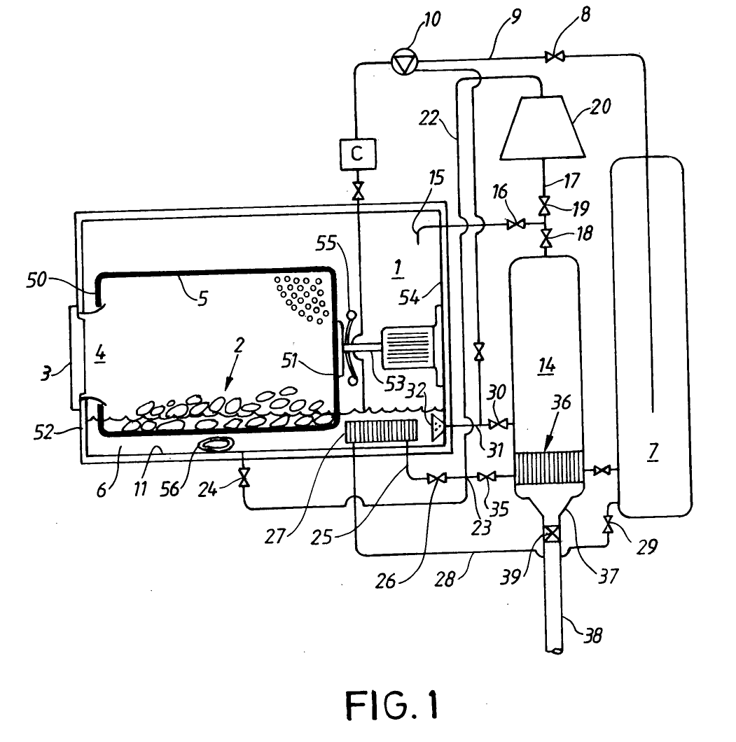

FIG. 1 shows a variant of the invention having a wash drum in the pressure chamber and an evacuation container disposed outside thereof, and

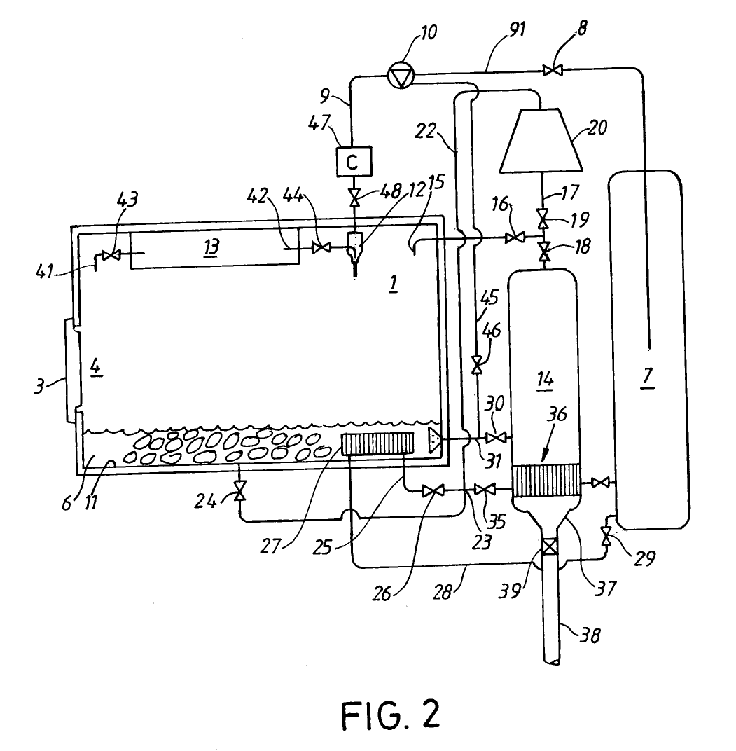

FIG. 2 shows a variant without wash drum and with the evacuation container enclosed in the pressure chamber.

With reference to FIG. 1 the first preferred embodiment of the invention will be described more in detail.

An arrangement for cleaning of porous materials, such as textiles, by means of liquid carbon dioxide has a pressure chamber 1 in which laundry 2 is placed and then a door 3 is operated to close the inlet opening 4 of the pressure chamber. In one variant of the invention the laundry 2 is placed in a rotatable drum 5. When the door 3 has been secured by means of a locking device of a known type liquid carbon dioxide 6 is supplied into the pressure chamber 1. The supply takes place from a storage tank 7 containing liquid carbon dioxide at a temperature in the range of 15 to 27° C. The carbon dioxide is conveyed from the storage tank 7 via a stop valve 8 and through a conduit 9 either by gravity or by means of a pump 10 in the conduit. This first conduit 9 opens in the pressure chamber 1. The conduit ends either openly in the pressure chamber or by means of an ejector pump 12 which is comprised in the conduit in the pressure chamber. When the liquid carbon dioxide has been supplied to the pressure chamber 1, to a selected level therein, the stop valve 8 is closed. Above the liquid carbon dioxide the pressure chamber 1 is filled with carbon dioxide gas which is mixed with the air initially present in the chamber. During the coming wash process the oxygen in the air can serve for oxidation of certain dirt remainders. For that reason it is not necessary to evacuate the air in connection with the filling of carbon dioxide into the pressure chamber 1.

Due to the vaporizing of the liquid carbon dioxide, at the given temperatures the pressure in the pressure chamber 1 will be between 4.5 MPa and 6.0 Mpa. Accordingly, the arrangement, as a whole, has to be constructed to sustain these pressures.

In order to perform the pulsating boiling, characteristic for the method, the arrangement has been provided with a container disposed in the immediate vicinity of the pressure chamber 1 and referred to as an evaporator 14. The evaporator 14 is connected to the pressure chamber 1 via an outlet 15 from the pressure chamber which is provided with a stop valve 16. The outlet 15 from the pressure chamber 1 is connected to a conduit 17 which is connected to the evaporator 14 via a stop valve 18. At the other side of the joint between the outlet conduit 15 and the conduit 17, and opposite the stop valve 18 there is provided another stop valve 19 for a compressor 20 included in the conduit 17. A more detailed description of the compressor will be given below.

When the required volume of carbon dioxide 6 has been supplied to the pressure chamber 1, in the variant with the wash drum 5, said drum is brought into rotation by an electric motor 21 enclosed in the pressure chamber 1. In an embodiment without wash drum the laundry 2 is only left for a while to be wet by the carbon dioxide 6. In the meantime the evaporator 14 is evacuated by keeping open the stop valves 18 and 19 in the conduit 17 (the stop valve 16 in the outlet 15 from the pressure chamber 1 is kept closed) and the compressor 20 is started. During the first cycle in accordance with the method the air sucked from the evaporator 14 is conveyed from the compressor into the surrounding atmosphere. During subsequent cycles carbon dioxide, compressed into liquid state, will leave the compressor 20 via a conduit 22 which, via a cross pipe 23 and a valve 24, open during this moment, conveys the liquid into the pressure chamber 1 through the bottom 11 thereof.

After the evaporator 14 has been evacuated to a pressure of about 0.3 MPa the valve 19 to the compressor 20 is closed and the compressor stops. Then, the valve 16 in the outlet 15 from the pressure chamber 1 is rapidly opened and is kept open for about five seconds.

As a result, the pressure in the pressure chamber drops and momentary boiling in the liquid carbon dioxide takes place in that steam bubbles are formed between the fibres of the laundry 2. The bubbles have an effect like mechanical treatment of the laundry at micro-level. At the same time dirt particles dissolved in carbon dioxide expand and contribute to the dissolving or dispersing thereof in the liquid phase.

When the stop valve 16 in the outlet 15 is closed the electric motor 21 is started rotating the drum 5 in alternate directions of rotation causing the laundry 2 to be exposed to mechanical treatment. In the variant without a rotating wash drum the laundry is kept in the liquid carbon dioxide while the gas bubbles rises to the surface thereof under heavy stirring of the liquid. In both cases 30 to 50 seconds are given for degassing of the laundry during which the pressure in the pressure chamber 1 returns to almost the same level as before the evacuation to the evaporator 14. Then, the stop valve 16 in the outlet 15 is again opened for about five seconds for the purpose of introducing carbon dioxide gas from the pressure chamber 1 into the evaporator 14 to cause a new momentary boiling in the liquid carbon dioxide. In this way, depending on the volume of the evaporator, the capacity of the compressor and the process time chosen, a number of boiling cycles can be performed before the pressure in the evaporator has increased to a level approaching the pressure in the pressure chamber 1.

Normally, about ten boiling cycles can be sufficient for the laundry 2 to be completely clean. Because a complete cycle from one boiling to the next is carried out in less than one minute the boiling cycles are repeated a number of times required with regard to the fibre quality and the degree of dirtiness. This is performed by again evacuating the evaporator 14 in the following way. The valve 19 in the connecting conduit 17 is opened to the compressor 20 which starts lowering the pressure in the evaporator 14. The compressor 20 is of the two-stage type and thereby the compressor is able to compress the carbon dioxide gas from the evaporator 14 to a pressure above that prevailing in the pressure chamber. The mechanical energy of the compressor 20 is transferred into heat energy and in order to make use of it and of the heat of evaporation of the carbon dioxide the high-pressure gas is conveyed through the conduit 22 from the pressure side of the compressor, via the cross-pipe 23 and past a valve 26 enclosed in a first branch 25 of the cross-pipe and to a heat exchanger 27 disposed in the liquid space of the pressure chamber 1. Alternatively, the carbon dioxide gas can be returned into the liquid in the pressure chamber 1.

When the pressure in the pressure chamber 1 is lowered and the liquid carbon dioxide boils heat of evaporation is taken from the wash liquid in the form of sensible heat causing its temperature to decrease. Compensation is given by the liquid which enters the heat exchanger 27 giving off its heat to the liquid carbon dioxide. From the heat exchanger 27 the liquid, now cooled to the temperature of the surrounding atmosphere, is conveyed through a conduit 28 past an inlet valve 29 to the storage tank 7. The pressure chamber is refilled from the storage tank 7 via the conduit 9.

When a sufficient number of wash cycles have been performed the liquid carbon dioxide 6 is drained from the pressure chamber 1 to the evaporator 14 by opening of a valve 30 in a conduit 31 connecting the pressure chamber with the evaporator.

If allowed by the premises in which the arrangement is disposed the evaporator 14 is mounted at such a low level that the draining of the washing liquid 6 from the pressure chamber 1 can take place by gravity. Otherwise a pump must be provided for the transport of the liquid in case the gas pressure in the pressure chamber 1 cannot be considered to effect a satisfactory draining. In one way or the other the pressure chamber 1 is emptied of liquid carbon dioxide via the conduit 31 to the evaporator 14, and, of course, the high pressure in the pressure chamber 1 will assist. When all liquid carbon dioxide has been transferred to the evaporator 14 and a pressure equilibrium has been reached between the evaporator and the pressure chamber 1, the valve 30 in the conduit 31 is closed. Thereafter, drying of the laundry 2 takes place. Drying is performed in the following way until the pressure of the carbon dioxide gas in the pressure chamber 1 has lowered to between 0.25 to 0.5 MPa.

The compressor 20, which is of the two-stage type, is started and the valve 16 in the outlet 15 from the pressure chamber 1 is opened as well as the valve 19 in the conduit 17 connected to the compressor. Hereby, the compressor can suck carbon dioxide gas from the pressure chamber and compress same. The rise in temperature of the carbon dioxide, caused by the compression, is used in that the high-pressure gas is conveyed from the compressor 20 via the conduit 22 and to the cross pipe 23 and further via the heat exchanger 27 in the pressure chamber 1 where the carbon dioxide gas gives off its heat compensating for the heat consumed during drying of the laundry. The cooled liquid carbon dioxide is conveyed from the heat exchanger 27 through the conduit 28 past the stop valve 29 and to the storage tank 7.

In the variant including a rotatable wash drum 5 the laundry is allowed to be tumbled by the drum at least during part of the drying cycle, normally lasting for 15 minutes. At the end of the drying cycle the pressure in the pressure chamber is lowered down to atmospheric pressure whereupon the door 3 can be opened and the laundry 2 removed from the machine.

Prior to the next-coming wash batch the liquid carbon dioxide transferred from the pressure chamber 1 to the evaporator 14 is re-generated. Re-generation takes place by opening of the valves 18 and 19 in the conduit 17 from the evaporator 14 to the compressor 20 and by opening of a valve 35 in a second branch of the cross pipe 23 in the conduit 22. All valves connecting to the pressure chamber 1 and its heat exchanger 27 are kept closed during the re-generation process.

When the compressor 20 is started it sucks carbon dioxide gas from the evaporator 14 and the high-pressure gas leaving the compressor is conveyed through the conduit 22, the cross pipe 23 and the valve 35 to a second heat exchanger 36 placed close to the bottom in the evaporator. From the second heat exchanger 36 the cooled liquid carbon dioxide is conveyed to the storage tank 7.

Due to the fact that the heat supplied to the gas by the compressor 20 and the vaporization heat are recovered in the heat exchanger 36 and supplied to the carbon dioxide in the evaporator 14, this will contribute to quickly drive-off the carbon dioxide from the evaporator. If the evaporator has a volume of 100 litres and contains 50 litres of liquid carbon dioxide a two-stage compressor of 8 kW power in each stage can manage the vaporization in about two minutes.

The vaporization is a kind of distillation and, accordingly, the liquid condensed in the heat exchanger 36 is completely free from impurities in the form of dirt remainders. These have been collected in a sump 37 formed in the bottom of the evaporator 14. From here the impurities are blown-off through a discharge pipe 38 after closing of all valves of the system and opening of a valve 39 provided in the discharge pipe. Driving force is the remaining gas pressure in the evaporator.

The carbon dioxide loss in the arrangement described is below 1.7 kg/wash. This amount is compensated for by supply from the storage tank 7 at the start of a new wash batch.

The method as used in the second variant will now be described with reference to FIG. 2 in which the evaporator 14 has been replaced by an evacuation container 13 disposed in the pressure chamber 1. The function of the evacuation container is to receive carbon dioxide gas from the pressure chamber for lowering of the boiling point of the liquid phase therein. The interior of the container 13 is connected to the pressure chamber by an inlet 41 and an outlet 42. A stop valve 43 is provided in the inlet and a stop valve 44 in the outlet.

At the first filling of the pressure chamber 1 with carbon dioxide the stop valve 43 in the inlet 41 of the container 13 is kept closed and also the stop valve 44 of the outlet 42. Accordingly, atmospheric pressure is prevailing in the container. Carbon dioxide is supplied from the storage tank 7 by means of the pump 10 via the conduit 9 which connects to the inlet side of the ejector pump 12.

Irrespective of performed in accordance with the simpler variant with the laundry 2 just resting in the liquid carbon dioxide, which of course has to cover the whole batch of laundry, or in accordance with the more sophisticated variant with assistance of the rotatable drum 5, from now on the method will be the same. However, of course there will be a difference in that the rotatable drum 5, driven by an electric motor 21 enclosed in the pressure chamber, will be rotated in alternate directions of rotation for tumbling the laundry to effect the complete penetration of the carbon dioxide between the fibres of the laundry for wetting of same.

Tests made have been carried out mainly corresponding to those made by use of the first variant. Then, the method has been performed as follows.

The stop valve 43 in the inlet 41 to the container 13 ir rapidly opened and is kept open for five seconds.

As a result the pressure in the pressure chamber drops causing momentary boiling in the liquid carbon dioxide to be effected in that steam bubbles are formed between the fibres of the laundry 2. These bubbles effect a mechanical treatment of the laundry at micro-level.

Upon closing of the stop valve 43 in the inlet 41 of the container 13, in the variant without a wash drum the laundry is just left to rest in the liquid carbon dioxide while the gas bubbles rise the surface thereof. Also in this case the laundry is given 30 to 50 seconds of degassing wherein the pressure in the pressure chamber returns to almost the same level as before the evacuation to the container 13. Then, the stop valve 43 in the inlet 41 is again opened for about five seconds in order to introduce carbon dioxide gas from the pressure chamber 1 into the container 13 for causing a new momentary boiling in the liquid carbon dioxide. In this way, dependent on the volume of the container, four or five such boiling cycles can be performed before the pressure therein has increased so as to approach the pressure in the pressure chamber.

Normally, this number of boiling cycles can be sufficient in order for the laundry 2 to be completely clean. However, because a whole cycle from one boiling phase to the next is carried out in less than one minute the boiling cycles are repeated a few more times. This is made possible by evacuation of the container 13 in the following way.

Via a suction conduit 45, branched-off from the discharge pipe 31 of the pressure chamber 1, the pump 10 is connected to the inlet of this conduit close to the bottom 11 of the pressure chamber 1. In the suction conduit 45 of the pump 10 a stop valve 46 is provided. By opening of valve 46 the pump 10 is started sucking liquid carbon dioxide from the pressure chamber 1 via the conduit 45. At the pressure side of the pump 10 the carbon dioxide passes through a cooler 47 which lowers the temperature of the liquid to a level of five to ten centigrades below the temperature in the pressure chamber 1.

When the stop valve 46 is opened, simultaneously also a valve 48 is opened which is disposed downstream of the cooler 47 in the conduit 91, 9 coming from the storage tank 7. A stop valve 8, disposed upstream of the pump in this conduit, is kept closed in this stage of the method. From the stop valve 48 the liquid flows through the ejector pump 12 and after opening of the valve 44 in the outlet 42 from the container 13 the process continues with evacuation of the container 13 down to 0.3 MPa.

The cooling of the liquid carbon dioxide led to the ejector pump 12 has the effect that the carbon dioxide gas sucked from the container 13 is easily condensed and returns in the form of liquid to the wash liquid in the lower part of the pressure chamber 1. Even in a case where the wash liquid contains water vaporized in connection with the momentary boiling of the carbon dioxide, also this water will be condensed.

After a desired number of boiling pulsations have been performed the valve 48 in the inlet to the ejector pump 12 is closed and the pump 10 stops. For the re-generation of carbon dioxide, subsequently the valve in the discharge pipe 31 of the pressure chamber 1, leading to the evaporator 14, is opened. The gas pressure in the pressure chamber 1 pushes the liquid carbon dioxide over to the evaporator and when pressure equilibrium between these two has been reached the valves 22 and 24 in the conduit 21 are opened to the compressor 20 which starts. The high-pressure gas is conveyed from the compressor through the conduit 22, via the cross-pipe 23 and valve 35 to the heat exchanger 36 of the evaporator 14. When the gas therein has given off its surplus heat, resulting from the mechanical work of the compressor 20, and being transformed into liquid phase the carbon dioxide is further conveyed to the storage tank 7. After that, the method is similar to the variant previously described.

In the case of particular sensitive fibres, for example if they do not stand explosive boiling, the boiling can be accomplished my means of the ejector only, the discharge of which is then conveyed to the storage tank 7. The suction side of the feeding pump 10 of the ejector 12 draws liquid carbon dioxide from the storage tank through the conduit 91, 9.

In a special embodiment the arrangement is provided with an ultrasonic probe 56 disposed at the bottom 11 of the pressure chamber 1. The purpose of the probe is to generate vibrations in the wash liquid and so improve the removal of dirt from the laundry 2.

For a man skilled in the art it is obvious to select equipment for the control of valves and remaining components of the arrangement. He also realizes how, within the scope of the claims, the method can be varied and the arrangement adapted accordingly.

1. Method for cleaning of porous materials by means of liquid carbon dioxide, the material being placed in a pressure-tight chamber partly filled with the carbon dioxide, characterized in that the pressure in the chamber is lowered in an intermittent, rapid way by opening of a valve between the chamber and an evacuated adjacent container.

2. Method according to claim 1, characterized in that the lowering of the pressure is performed repeatedly during the course of a cleaning operation.

3. Method according to claim 2, characterized in that the lowering of the pressure is performed at least five times during a cleaning operation.

4. Method according to claim 3, characterized in that the lowering of the pressure is performed about ten times during a cleaning operation.

5. Method according to any of the claims 1-4, characterized in that between each drop the pressure in the chamber is again increased.

6. Method according to claim 5, characterized in that the increase of the pressure is accomplished by supplying liquid carbon dioxide by means of a pump from a storage tank to the pressure chamber.

7. Method according to claim 5, characterized in that the increase of the pressure is accomplished by supplying carbon dioxide from the pressure chamber to an ejector, the suction side of which is connected to the container and hence evacuates it after closing of the valve, the outlet of the ejector opens into the pressure chamber.

8. Method according to claim 5, characterized in that the increase of the pressure is accomplished by heating the carbon dioxide.

9. Method according to any of the claim 1-4, characterized in that the heat of evaporation absorbed by the carbon dioxide gas during the boiling caused by the pressure drops is returned to the liquid carbon dioxide.

10. Arrangement for carrying out the method according to claim 1, wherein porous material goods are placed in a pressure chamber (1) to be washed in liquid carbon dioxide, characterized by a container (13,14) for the control of the carbon dioxide pressure in the pressure chamber (1), and a first connection conduit (41,15) adapted to interconnect the container and the pressure chamber and being provided with a stop valve (43,16), the container (13,14) having an outlet evacuation conduit (42,17) comprising a pump (12)/compressor (20) at the inlet side of which a second stop valve (48) is provided.

11. Arrangement according to claim 10, characterized in that the pump (12) is of the ejector type.

12. Arrangement according to claim 11, characterized in that the ejector pump is supplied with liquid carbon dioxide via a feed conduit (9) from a pump (10).

13. Arrangement according to claim 11, characterized in that the pump (10) is connected to a feeding conduit (91) from a storage tank (7) from which liquid carbon dioxide is supplied to the pressure chamber.

14. Arrangement according to claim 10, characterized in that a drum (5) for supporting the goods to be washed is provided in the pressure chamber (1), said drum having an essentially cylindrical form with perforated envelope surface.

15. Arrangement according to claim 14, characterized in that the drum (5) has an open and a closed gable (50, 51), the open gable being situated opposite to a door (3) provided in one side wall (52) of the pressure chamber (1), a shaft (53) extending from the centre of the closed gable (51) forming the drive shaft of an electric motor (21) fixedly mounted in the pressure chamber (1) for rotating the drum (5).

16. Arrangement according to claim 15, characterized in that the shaft (53) of the drum (5) is journalled in the other, opposite side wall (54) of the pressure chamber (1) and that between the closed gable of the drum (5) and the other side wall (54) of the pressure chamber (1) an impeller (55) is provided on the shaft (53), the outlet jet of the ejector pump (12) being directed towards the impeller (55) for rotation of the drum (5).

17. Arrangement according to claim 15, characterized in that the shaft (53) of the drum (5) is journalled in the other side wall (54) of the pressure chamber (1), two impellers of opposite directions being provided on the shaft between the closed gable (51) of the drum (5) and the other side wall (54) of the pressure chamber (1), the outlet jet of the ejector pump (12) being alternately directed towards the respective impeller for alternate directions of rotation of the drum (5).

18. Arrangement according to claim 17, characterized in that a partition is provided between the impellers.

19. Arrangement according to any of claims 10-18, characterized in that in the container (14) a heat exchanger (36) is disposed in which condensation takes place of high-pressure gas from the compressor (20).

20. Arrangement according to any of claims 10-19, characterized in that in the pressure chamber (1) a heat exchanger (27) is provided in which condensation takes place of high-pressure gas from the compressor.

21. Arrangement according to any of claims 11-13, characterized in that in the conduit (9) to the ejector pump (12) a cooler (47) is provided.

22. Arrangement according to any of claims 10-21, characterized in that an ultrasonic probe (56) is provided adjacent to the bottom (11) of the pressure chamber (1).
